(19) United States
(12) Patent Application Publication
(10) Pub. No.: US 2006/0036770 A1
(43) Pub. Date: Feb. 16, 2006

(54) System for factoring synchronization strategies from multimodal programming model runtimes

(75) Inventors: Rafah A. Hosn, New York, NY (US); Jaroslav Gergic, Kocbere (CZ); Nai Keung Thomas Ling, White Plains, NY (US); Charles Wiecha, Hastings-on-Hudson, NY (US)

Correspondence Address: F. CHAU & ASSOCIATES, LLC, 130 WOODBURY ROAD, WOODBURY, NY, 11797, US

(73) Assignee: International Business Machines Corporation, Armonk, NY (US)

(21) Appl. No.: 10/909,144

(22) Filed: Jul. 30, 2004

(51) Int. Cl. G06F 15/16

(52) U.S. Cl. 709/248

(57) ABSTRACT

A factored multimodal interaction architecture for a distributed computing system is disclosed. The distributed computing system includes a plurality of clients and at least one application server that can interact with the clients via a plurality of interaction modalities. The factored architecture includes an interaction manager with a multimodal interface, wherein the interaction manager can receive a client request for a multimodal application in one interaction modality and transmit the client request in another modality, a browser adapter for each client browser, where each browser adapter includes the multimodal interface, and one or more pluggable synchronization modules. Each synchronization module implements one of the plurality of interaction modalities between one of the plurality of clients and the server such that the synchronization module for an interaction modality mediates communication between the multimodal interface of the client browser adapter and the multimodal interface of the interaction manager.

### BACKGROUND OF THE INVENTION

Multimodal interaction is defined as the ability to interact with an application using multiple modes; for example, a user can use speech, keypad or handwriting for input and can receive output in the form of audio prompts or visual display. In addition to using multiple modes for input and output, user interaction is synchronized: for instance, if a user has both GUI and speech modes active on a device and he/she provides an input field via speech, recognition results may be reflected by both an audio prompt and a GUI display.

In today's multimodal frameworks, synchronization between various channels is either hardwired in applications markup pages using scripts, as is the case in Microsoft's SALT (Speech Application Language Tags) specification, or it is embedded inside a multimodal client. This implies that any changes to multimodal programming models require a re-authoring of already deployed applications and/or a release of new versions of multimodal clients. This greatly increases the cost of software maintenance and discourages customers and service providers from adopting new and improved multimodal programming models.

Multimodal interaction always entails some form of synchronization. There are various ways in which multiple channels become synchronized during a multimodal interaction. In a tightly coupled type of synchronization, user interaction is reflected equally in all modalities. For example, if an application uses both audio and GUI to ask a user for a date, when the user says “June 5th”, the result of the recognition is played back to him in speech and displayed to him in his GUI display as “06/05/2004”. Contrast this with a loosely coupled type of synchronization, which is dominant in rich conversational multimodal applications where modalities are typically used to complement each other rather than to supplement each other. In the latter form of synchronization, a user might say his itinerary using one sentence, “I want to go to Montreal tomorrow and return this Friday”, and have the list of available flights that satisfy his constraints returned in his GUI display as a selection list so that he can choose the flight that best suits his constraints. In both cases, software developers must use programming models that enable them to author either form of interaction.

Multimodal interaction is still at its infancy; various multimodal programming models are emerging in the industry, such as SALT and X+V (XHTML plus Voice). As multimodal matures in the market place, various incarnations of these programming models or variants of them might be adopted, each of which defines a particular synchronization strategy. In order to maintain the middleware being developed for such applications, it is necessary to create an architecture and a multimodal data flow process that can factor out the particularity of each programming model from the rest of the software components that support it. In the case of multimodal programming models, the particularity lies in the synchronization and authoring strategy adopted by each model. Factoring guarantees interoperability, efficient code maintenance, and an easier migration path for developers and service providers.

### SUMMARY OF THE INVENTION

The invention provides an architecture for factoring synchronization strategies and authoring schemes from the rest of the software components needed to handle a multimodal interaction. By implementing this aspect of the invention, both the client side (a modality-specific user agent) and the server-side infrastructure are made agnostic to a particular multimodal authoring technology and/or standard. This means client devices (deployed in vast numbers) can remain intact even though the underlying programming model is changing. On the server side, it means the existing infrastructure can either migrate seamlessly to a new multimodal standard and/or support multiple multimodal progamming models simultaneously; this a significant benefit for application service providers that need to support a wide range of technologies and standards to satisfy diverse cusomers' requirements.

Supporting the claim above is a mechanism by which the factored out synchronization strategy components, henceforth refered to as Synclets, communicate with the rest of the runtime components. According to a first aspect of the invention, there is provided a factored multimodal interaction architecture for a distributed computing system that includes a plurality of client browsers and at least one multimodal application server that can interact with the clients by means of a plurality of interaction modalities. The factored architecture includes an interaction manager with a multimodal interface, wherein the interaction manager can receive a client request for a multimodal application in one interaction modality and transmit the client request in another modality, a browser adapter for each client browser, each browser adapter including the multimodal interface, and one or more pluggable synchronization modules. Each synchronization module implements one of the plurality of interaction modalities between one of the plurality of clients and the server so that a synchronization module for an interaction modality mediates communication between the multimodal interface of the client browser adapter and the multimodal interface of the interaction manager.

In another aspect of the invention, the architecture includes a servlet filter that can intercept a client request for a multimodal application, and can pass that client request and a library of synchronization modules to the interaction manager, so that the interaction manager can select a synchronization module appropriate for the client request from the library of synchronization modules.

In another aspect of the invention, each multimodal interface of a client browser adapter and the multimodal interface of the interaction manager can communicate via a plurality of multimodal messages, and a synchronization module for an interaction modality is instantiated by the interaction manager upon receiving a client request for that interaction modality, so that the synchronization module can implement an exchange of multimodal messages between the multimodal interface of the client browser adapter and the multimodal interface of the interaction manager.

In another aspect of the invention, the architecture includes a synchronization proxy for each client for encoding the multimodal messages in an internet communication protocol.

In another aspect of the invention, the multimodal messages include multimodal events and multimodal signals.

In another aspect of the invention, the interaction manager is a state machine having an associated state, a loaded state, a ready state, and a not-associated state; the client browser adapter is a state machine having an associated state, a loading state, a loaded state, and a ready state; and a synchronization module is a state machine having an instantiated state, a loaded state, a ready state, and a stale state.

In another aspect of the invention, the client browser adapter enters the associated state when a connection to either the interaction manager or another client has been established; the client browser adapter enters the loading state when it is loading a document; the client browser adapter enters the loaded state when it has completed loading the document; and the client browser adapter enters the ready state when it is ready for multimodal interaction.

In another aspect of the invention, the synchronization module enters the instantiated state when it has been instantiated but has no document to process; the synchronization module enters the loaded state when it has been given a document to process but is waiting for a loaded signal from a client; the synchronization module enters the ready state when it is ready to receive events and send synchronization commands; and the synchronization module enters the stale state when the document being handled is no longer in view for the client.

In another aspect of the invention, the interaction manager enters the associated state when any non-stale synchronization module is in the instantiated state; the interaction manager enters the loaded state if any non-stale synchronization module is in the loaded state; the interaction manager enters the ready state if all non-stale synchronization modules are in the ready state; and the interaction manager enters the not-associated state when there is no client session associated with it.

In further aspect of the invention, the architecture includes an event control interface, by which a client browser adapter or the interaction manager can register or remove an event listener, or dispatch an event to another client browser adapter or to the interaction manager; a command control interface by which a client browser adapter or the interaction manager can modify the state of another a client browser adapter by issuing a synchronization command; and an event listener interface that can provide an event handler to a client browser adapter or the interaction manager.

These aspects of the invention define a modality independent and multimodal programming model agnostic protocol (a set of interaces), herein referred to as the Multimodal On Demand (MMOD) protocol.

### BRIEF DESCRIPTION OF THE DRAWINGS

FIG. 1 is a block diagram depicting a generic multimodal architecture.

FIG. 2 is a block diagram depicting a typical multimodal interaction manager architecture.

FIG. 3 is a block diagram depicting the factorization of synchronization stratgies from the multimodal interaction manager of FIG. 2.

FIG. 4 depicts a flowchart illustrating the setup process as a user loads a multimodal application.

FIG. 5 depicts a flowchart illustrating the data flow as a user interacts with a multimodal application.

FIG. 6 is a block diagram depicting architecture of the multimodal interaction manager of a preferred embodiment of the invention.

FIGS. 7a-b depict the sequence of MMOD messages exchanged for an X+V multimodal session.

FIG. 8 is an XHTML+Voice example for the message exchange depicted in FIGS. 7a-b.

### DETAILED DESCRIPTION OF A PREFERRED EMBODIMENT OF THE INVENTION

Multimodal Runtime Components

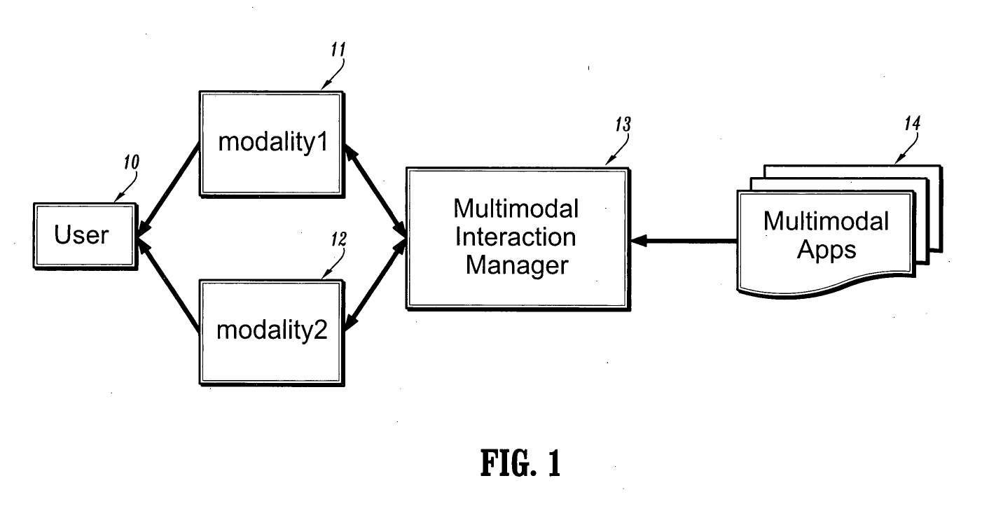

Multimodal interaction requires the presence of one or more modalities, a synchronization module and a server capable of serving/storing the multimodal applications. Users interact via one or more modalities with applications, and their interaction is synchronized as per the particular programming model used and the authoring of the application. The schematic diagram depicted in FIG. 1 shows a generic multimodal architecture diagram. User 10 interacts via modality 11 and modality 12 and multimodal interaction manager 13 with a plurality of multimodal applications 14.

The multimodal interaction manager is the component that manages interaction across various modalities. Interaction management entails various functionality, the main three being listed below:
1. channel communication
2. state management
3. synchronization

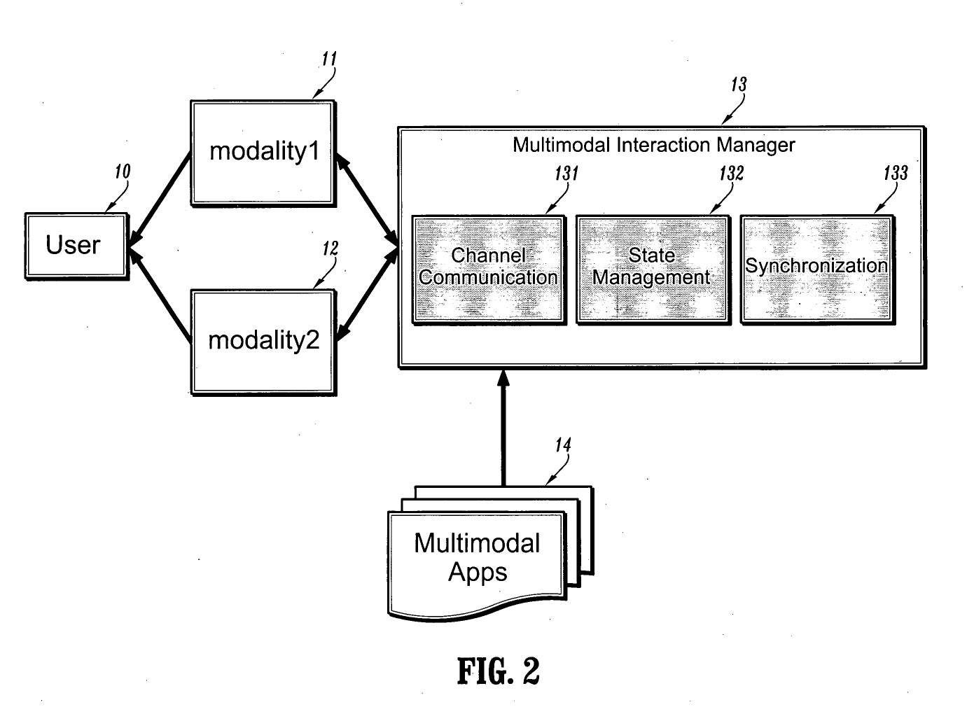

The architecture of a typical multimodal application is illustrated in FIG. 2. In a typical multimodal interaction manager 13, the channel communication component 131 is used to communicate between two or more modalities. The state management component 132 manages the state of the interaction management component and reflects also the state of the associated channels. The synchronization module 133 maintains the application state as well as the strategy of how and when to synchronize a user's action onto the various active modalities.

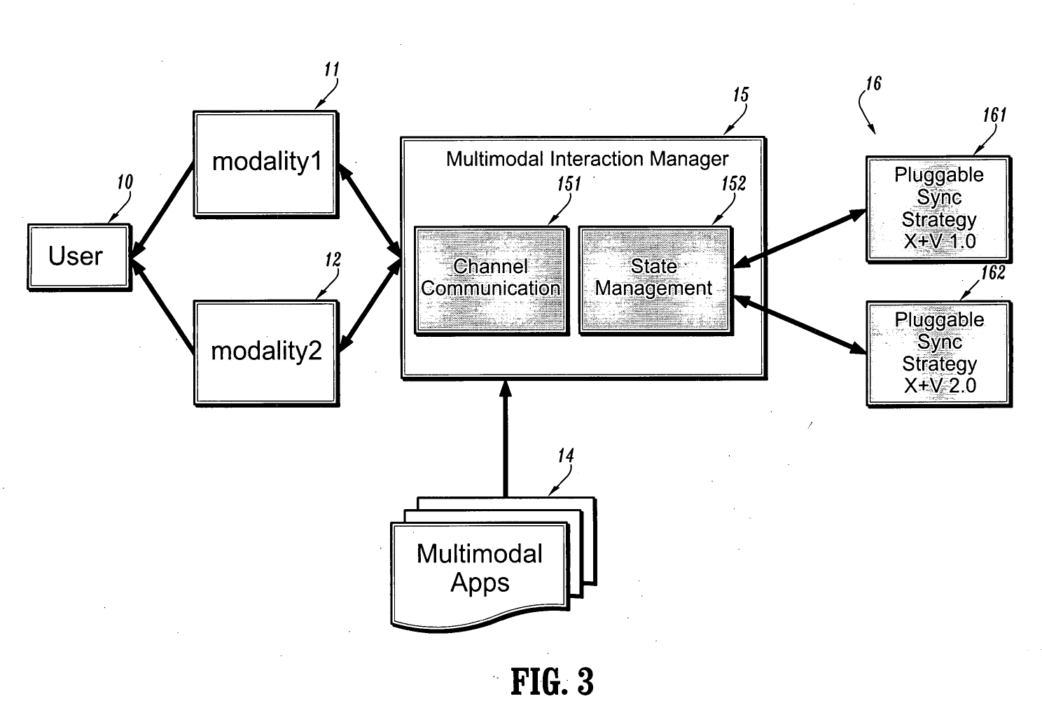

In a system of a preferred embodiment of the invention, the synchronization component of interaction management is factored out to allow the rest of the infrastructure to handle multiple programming models each with their own associated synclets. FIG. 3 presents a redrawing of the architecture depicted in FIG. 2, taking the factoring of the synclets into consideration, with multimodal interaction manager 15 replacing that of FIG. 2. Multimodal interaction manager 15 still includes channel communication component 151 and state management 152, but the synchronization components 160 have been factored out. For purposes of illustration, FIG. 3 depicts pluggable synchronization strategy synclets for X+V 1.0 and for X+V 2.0.

The factoring performed on the synclets allows various service providers to contract programmers to develop new synchronization strategies based on a new version af an existent multimodal programming model (as depicted in FIG. 3) or a new programming model, then plug them into the framework that is handling the interaction state. This ensures that applications deployed on various programming models can still be deployed without the need to migrate them.

Data Flow Process

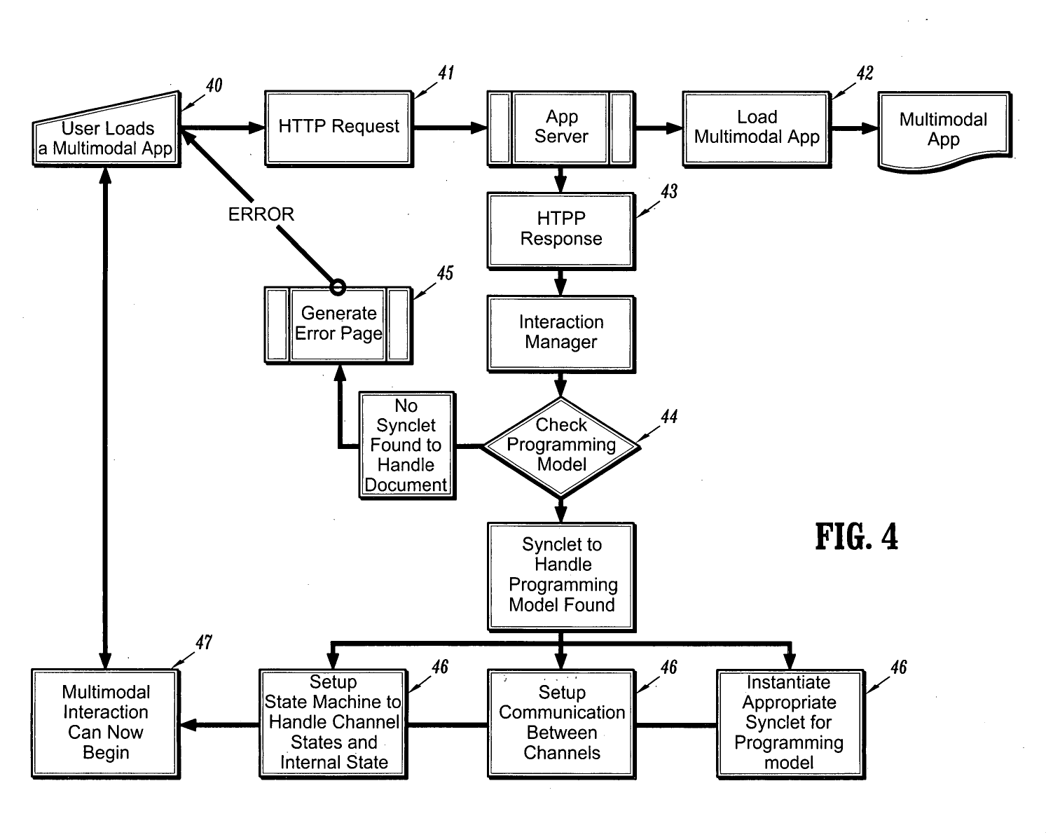

The diagram depicted in FIG. 4 illustrates the setup process as the user loads a multimodal application. At step 41, a user sends an HTTP request to load a multimodal application. An application server receives this request, and loads a multimodal application at step 42, and sends an HTTP response to the Interaction Manager (IM) at step 43. At step 44, the IM determines if a synclet exists to handle the programming model of the multimodal document. If a synclet is not found, an error report is generated at step 45, and the user is returned to step 40 and prompted to enter another multimodal application request. Otherwise, at step 46, the IM sets up a state machine to handle channel states and internal states, establishes communication between the various channels, and instantiates an appropriate synclet for the programming model. The multimodal interaction can begin at step 47. The key point in this process is the search for an appropriate synclet that can handle the multimodal document type being loaded as depicted in step 44.

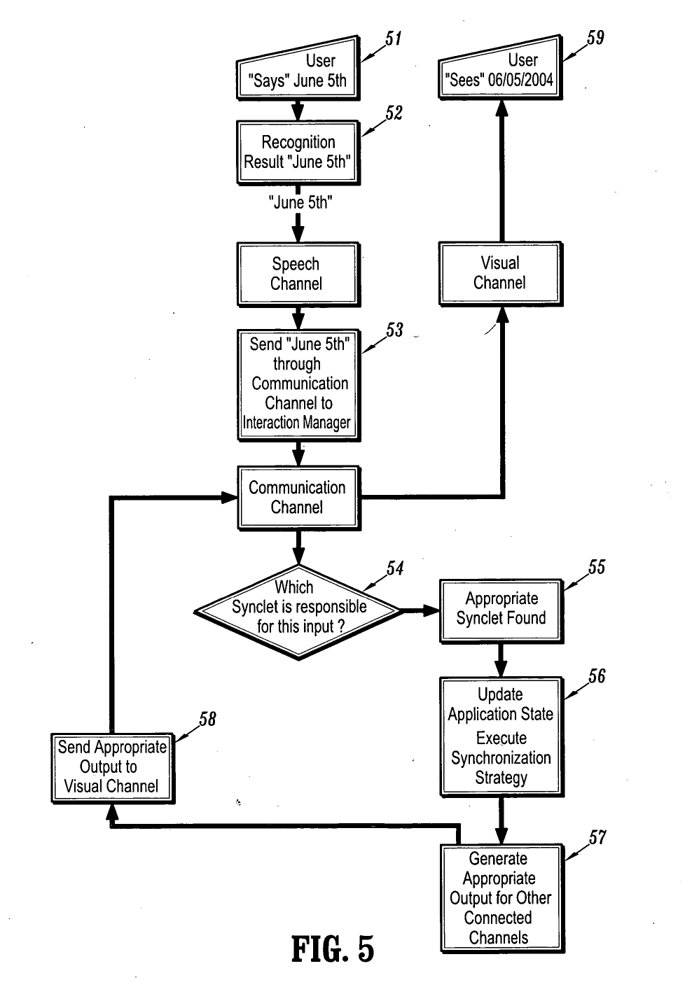

FIG. 5 depicts the data flow as a user interacts with a multimodal application. The data flow chart assumes that the user is using a device with both speech and visual modalities enabled. The multimodal application asks the user for a date, and the user responds via speech at step 51. In the example illustrated, it is assumed that the multimodal application is authored using tightly coupled synchronization so user's interaction is reflected in both modalities. Thus, at step 52, the speech channel recognizes the response, “June 5^{th}”, and echos it back to the user, and at step 53, sends “June 5^{th}” through the communication channel to the IM. At step 54, the IM determines which synclet is responsible for handing the visual modality for this input, and finds the synclet at step 55. The synclet then updates the application state and executes the synchronization strategy at step 56, and at step 57, generates an appropriate output for the visual channel. The synclet sends the appropriate output to the visual chennel via the channel communication component at step 58, so that the user sees “06/05/2004” at step 59.

Interaction Manager Framework

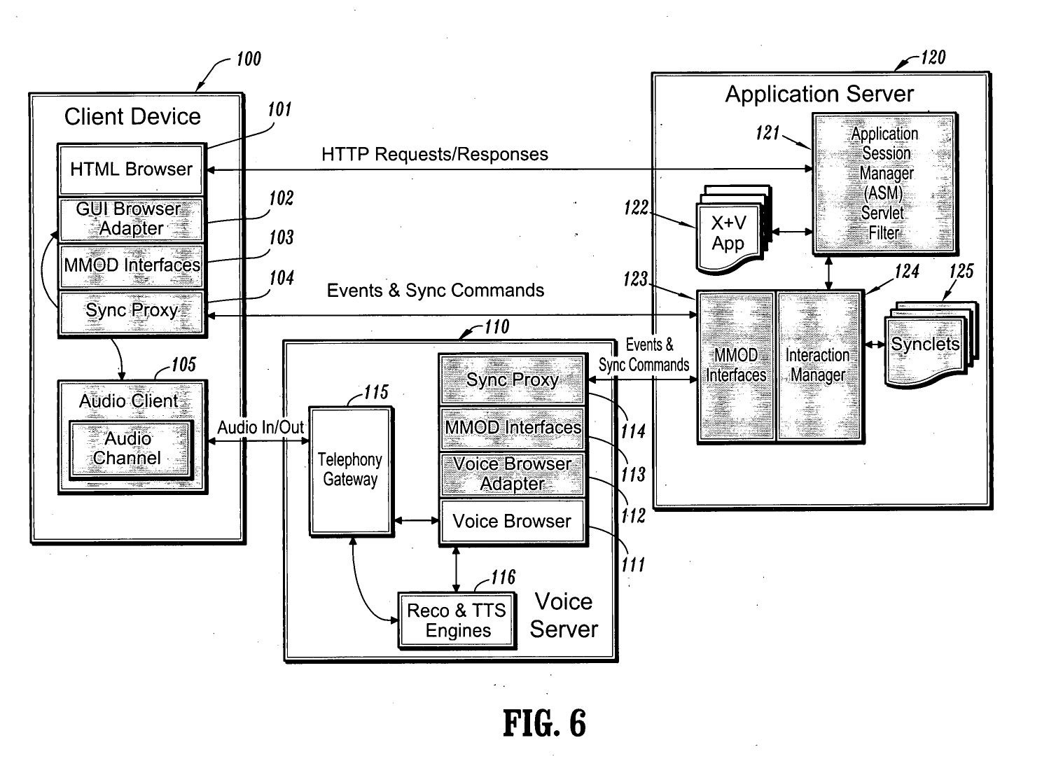

FIG. 6 depicts a block diagram of the high-level architecture of a preferred embodiment of the invention. This embodiment can include a client device 100, a voice modality server 110, and an application server 120. The voice modality server can function as a client device for the voice mode of interaction. In the embodiment depicted, it can include a telephony gateway 115 connected to an audio client 105 embedded in the client device 100, and a reco/TTS engine 116, both modules being standard components of voice servers. Note that the voice modality server 110 can be embedded in a client device. An example of a voice modality server is IBM's Websphere Voice Server.

The Interaction Manager (IM) is a framework that supports distributed multimodal interaction. As can be see from the figure, the Interaction Manager is placed server side and communicates with active channels through a set of common interfaces called Multimodal Interfaces On Demand (MMOD). These interfaces of this embodiment will be explained in conduction with an X+V application using a GUI and a voice modality. The factorization strategy of the emplary aspect of the invention is not limited to this embodiment, and is applicable to any client interacting with an application through muiltiple modalities.

Multimodal on Demand Servlet Filter

Referring to FIG. 6, the application session manager servlet filter 121 intercepts a request for a multimodal application 122, such as an X+V document as shown in the figure, and instantiates an Interaction Manager 124 for that user session. If the document is authored in XHTML+Voice, the servlet filter 121 will strip the voice content out of the XHTML+Voice document, and sends the XHTML portion to the requesting client 100. It then forwards the entire XHTML+Voice document to the instance of interaction manager 124 created for this session.

Interaction Manager

The Interaction Manager (IM) 124 is a composite object that typically (but not necessarily) resides server-side and is responsible for acquiring user interaction in one mode and publishing it in all other active modes. In a web environment, the IM can synchronize across multiple browsers, each supporting a particular markup language. In this context, each browser can constitute one interaction mode and thus the IM is responsible for:
1. Receiving events and signals from one browser
2. Finding appropriate action to take to reflect that user interaction in all other active browsers.
3. Dispatching cross-markup events and event handlers from one browser to another.
   Client Side Support for Distributed Multimodal Interaction

To establish and exchange information between the IM 124 and the various client devices 100 and 110, the clients 100, 110 must implement a set of generic multimodal interfaces called Multimodal On Demand (MMOD) interfaces 103, 113. The MMOD interfaces 103, 113 also define a set of messages that can be bound to multiple protocols, e.g. HTTP, SOAP, XML, etc. A distributed client must be able to implement at least one such encoding in order to send and receive MMOD messages over a physical connection. The SyncProxy modules 104, 114 of client devices 100, 110 are synchronization proxies each of which implement a particular encoding of the MMOD messages and is responsible for marshalling and unmarshalling events, signals and commands over the physical connection.

For maximum adaptability, the IM framework of the preferred embodiment of the invention does not assume that all browser vendors will implement MMOD and its associated protocol bindings. As such, the IM framework includes a set of Browser Adapter classes 102, 112 that implement these MMOD interfaces 103, 113 and SyncProxy classes 104, 114 that implement a particular encoding for MMOD messages. The framework currently contains support for the IE browser 101 and IBM's VoiceXML browser 111.

IM State Machine

The IM 124 has four states:
ASSOCIATED: IM has been instantiated and associated with a particular session.
LOADED: IM is waiting for all of its synchronization modules to be ready.
READY: IM is ready to handle events and issue synchronization commands on the active channels.
NOT_ASSOCIATED: IM is down, there is no connection to it.

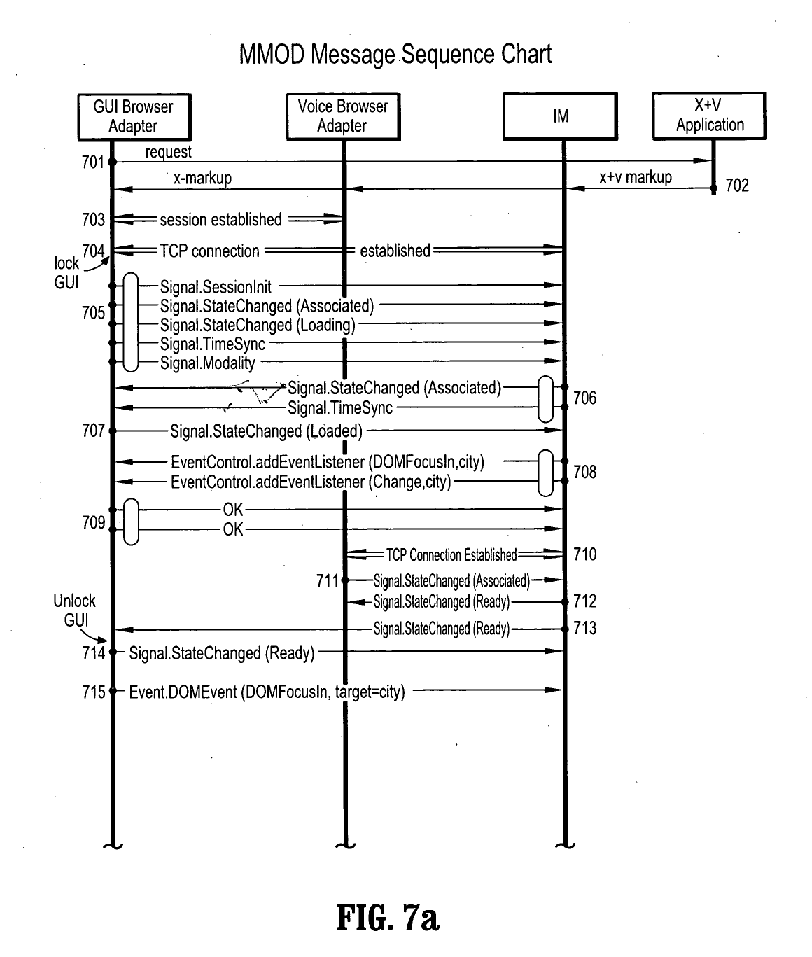

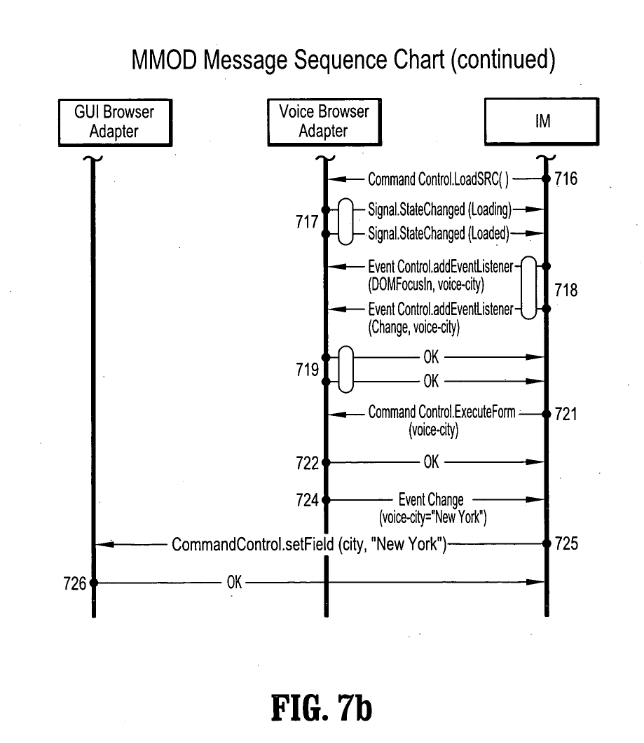

The IM's state transitions are dependent on the actual synchronization strategy being used during a particular user session. The sequence diagram depicted in FIGS. 7a-b, discussed below, illustrates an example of the IM's state transitions for an XHTML+Voice type of synchronization strategy.

Client State Machine

The IM framework of the preferred embodiment of the invention expects MMOD clients 100 to have the following states:
ASSOCIATED: client is up, connection has been established.
LOADING: client is loading a document.
LOADED: client has completed loading a document.
READY: client is ready for multimodal interaction, i.e to send events and receive synchronization commands.
   Pluggable Synchronization Strategies

The IM framework of the preferred embodiment of the invention makes no assumption as to the programming model followed to author the multimodal applications and, as such, can be used for a variety of multimodal programming models such as XHTML+Voice, XHTML+XForms+Voice, SVG+Voice etc. Each programming model typically dictates a specific synchronization strategy; thus to support multiple programming models one needs to support multiple synchronization strategies. The IM framework of the preferred embodiment of the invention defines a mechanism by which multiple synchronization strategies can be implemented without affecting the underlying middleware infrastructure or applications that have been already deployed. This design significantly reduces the time it takes to adopt new programming models and their corresponding synchronization strategies and ensures minimal outage time for applications already deployed on that framework.

Synclets

The synclets 125 are state machines that are implement a specific synchronization strategy and coordinate communication over the various channels. The IM framework of the preferred embodiment of the invention specifies a specific interface to which a synclet author must adhere, allowing these components to plug seamlessly into the rest of the IM framework. During a multimodal interaction with the IM, the MMOD servlet filter chooses a synclet library based on the multimodal document mime type. This synclet library is passed to the IM and the IM will use it to instantiate the appropriate synclet for that document type and bind it to that user session. The MMOD servlet filter will then hand the synclet the actual document. The synclet will then determine how to handle synchronization between the various active channels; as such it determines when and how to communicate events and synchronization commands from one channel to the other active channels.

Synclet State Machine

The IM framework of the preferred embodiment of the invention may include one more synclets each implementing one or more multimodal programming models. The state of all active synclets during a user session determines the IM's overall state as described in the first section. The IM polls each synclet for its state during a user interaction, sets its own state, then informs connected clients of that state. A synclet has four states:
1. INSTANTIATED: a synclet has been instantiated but has no document that it is processing.
2. LOADED: a synclet has been given a document to process and is waiting for a LOADED signal from a client.
3. STALE: the document the synclet is handling is no longer in view for the end user.
4. READY: the synclet is ready to receive events an send synchronization commands on active channels.
   The IM's overall state is set according to the following:
1. For all non-stale synclets, if any synclet is in the INSTANTIATED state, the IM transits into the ASSOCIATED state.
2. For all non-stale synclets, if any synclet is in the LOADED state, the IM transits into the LOADED state.
3. For all non-stale synclets, if all synclets are in the READY state, the IM transits into the READY state.
   Note that a synclet's state transitions depend on the synchronization strategy the synclet is implementing.
   Generic Multimodal Interfaces: Multimodal on Demand Interfaces

Another aspect of the preferred embodiment of the invention is a set of abstract interfaces and messages that allow endpoints in a multimodal interaction to communicate with each other, and a protocol to serialize and un-serialize MMOD messages. These endpoint interfaces are: (1) the Event Control interface; (2) the Command Control interface; and (3) the Event Listener interface. MMOD is designed as a web service. Its interfaces can be written in any language and its messages bound to a variety of protocols, such as SOAP, SIP, Binary or XML. These multimodal interfaces are key to establishing and maintaining communication with endpoints participating in a multimodal interaction. In addition, synclets and MMOD events each have an interface. In a distributed architecture as shown in FIG. 6, an MMOD interface is implemented by each client 100 communicating with the Interaction Manager 124, as well as by the Interaction Manager 124 to reciprocate in the communication. Following is the detailed description of these interfaces.

Event Control Interface

The following section of code specifies the interface that MMOD components, such as clients and the IM, use to register and remove event listeners as well as to dispatch events down a browser's tree.

```
interface EventControl {
/*
  * adds an event listener for a particular type on a
  * particular node. If the targetNodeId is a *,
  * the listener is added on all documents loaded by
  * the browser until an explicit “removeEventListner” is called.
  */
      void addEventListener (
            in WStringValue targetNodeId,
            in WStringValue eventType,
            in EventListener eventListener )
      raises (
            InvalidTargetEx,
            UnsupportedEventEx );
/*
  * removes an event listener for a particular type on
  * a particular node. If targetNodeId is *, it removes
  * all listeners for that event type.
  */
      void removeEventListener(
            in WStringValue targetNodeId,
            in WStringValue eventType,
            in EventListener eventListener );
/*
  * returns true if browser can export particular
  * event type, false otherwise.
  */
      boolean canDispatch (in WStringValue eventType );
/*
  * dispatches an event on browser's tree.
  */
      void dispatchEvent (
            in Event event )
      raises (
            InvalidTargetEx,
            UnsupportedEventEx );
};
```

Command Control Interface

This interface allows components to modify the browser's state by issuing synchronization commands on that browser's interface.

```
interface CommandControl {
// returns browser instance id
      WStringValue getInstanceId( )
      raises (CommandEx);
// makes browser load a document from a particular URL
      void loadURL( in WStringValue url );
// makes browser load an inlined document
      void loadSrc(
            in WStringValue pageSource,
            in WStringValue baseURL )
      raises (CommandEx);
// makes browser set focus on node with id targetId
      void setFocus(in WStringValue targetId )
      raises (CommandEx);
// retreives current focus in current page
      WStringValue getFocus( )
      raises (CommandEx);
// makes browser set a field value(s), given field id
      void setField(
            in WStringValue nodeId,
            in FieldValue nodeValue)
      raises (CommandEx);
// makes browser set a list of field value(s),
// given a list field id
      void setFields(
            in List nodeIds,
            in List nodeValues)
      raises (CommandEx);
// retrieves a field value(s), given its id
      FieldValue getField( in WStringValue nodeId );
// makes browser return a set of fields each having one or more
// values
      List getFields(in List nodeIds)
      raises (CommandEx);
// cancels form execution
      void abort( )
      raises (CommandEx);
// makes browser start executing form given its id
      void executeForm(in WStringValue formId )
      raises (CommandEx);
};
```

Event Listener Interface

This interface is implemented by any component that registers listeners for browser events. The method handleEvent is called whenever that event listener is activated.

interface EventListener {
// call back method of event listeners
void handleEvent(in Event event);
}

Synclet Interface

A synclet has the following interface:

```
interface Synclet {
// The document “fragment” is a org.w3c.dom.Document object
      public void setDocumentFragment(Document df)
      throws SyncletException, XVException, IOException;
// returns a document the synclet is working with
      public Document getDocumentFragment( );
// synclet support for xml data models like XForms
      public void setDataModel(Model dataModel);
// returns data model
      public Model getDataModel( );
// synclet's state
      public int getState( );
// called by SyncManager inside the IM framework when a synclet's
// document is no long active
      public void markStale( );
// flushes the synclet's buffers.
      public void reset( );
// synclet must be able to add listeners to a channel
      public void addEventListeners(ClientProxy cp);
// synclets must be able to handle events received on a
// particular channel
      public void handleEvent(Event event);
}
```

MMOD Events

In the X+V embodiment of the invention, the IM framework supports the following list of MMOD events. This list of events is not exhaustive, and other events can be defined for other interaction modalities.

| Event Name | Event Category |
|---|---|
| DOMActivate | UIEventDetail |
| DOMFocusIn | UIEventDetail |
| DOMFocusOut | UIEventDetail |
| Click | MouseEventDetail |
| Mousedown | MouseEventDetail |
| Mouseup | MouseEventDetail |
| Keydown | KeyboardEventDetail |
| Keyup | KeyboardEventDetail |
| Load | URL (String) |
| Unload | URL (String) |
| Abort | URL (String) |
| Error | ErrorStuct |
| Change | ValueChangeDetail |
| Submit | Map (String, FieldValue) |
| Reset | Map (String, FieldValue) |
| Help | Xinteraction |
| Nomatch | Xinteraction |
| Noinput | Xinteraction |
| Vxmldone | Map (String, FieldValue) |
| RecoResult | RecoResultDetail |
| RecoResultEx | RecoResultDetailEx |
| Custom | event name and value (String, String) |

Note that the Nomatch, Noinput, Vxmldone, RecoResult, and RecoResultEx events are defined for the voice interaction modality.

An MMOD event has the following interface:

```
interface Event {
// returns type of event
      WStringValue getType( );
// returns event namespace URI if any
      WStringValue getEventNamespace( );
// returns event target node id
      WStringValue getTargetID( );
// returns symbolic name of event source
      WStringValue getSourceID( );
// returns event creation time in milliseconds if any
      long long getTimeStamp( );
// returns user agent from which event came if any
      WStringValue getUserAgent( );
// returns id of command that resulted in this event being fired
      WStringValue getCommandId( );
// each event type has a specific detail section
      in Object getEventDetail( );
}
```

MMOD Signals

Alongside events that are asynchronous in nature, the MMOD protocol also defines a set of signals. Signals, like events, are asynchronous messages that get exchanged between various endpoints of a multimodal interaction. However, unlike events, signals are used to exchange lower level information about the actual participants in a multimodal interaction. The following example list of signals is not exhaustive, and other signals can be defined and still be within the scope of the preferred embodiment of the invention.
SessionInit: contains information on session id, modality and user agent;
StateChanged: reflects changes in the client state machine;
TimeSyncRequest: request for time synchronization;
TimeSyncResponse: response to a time synchronization request.

The time synchronization signals are used to correct for network latency that can result for geographically distributed clients.

MMOD Protocol

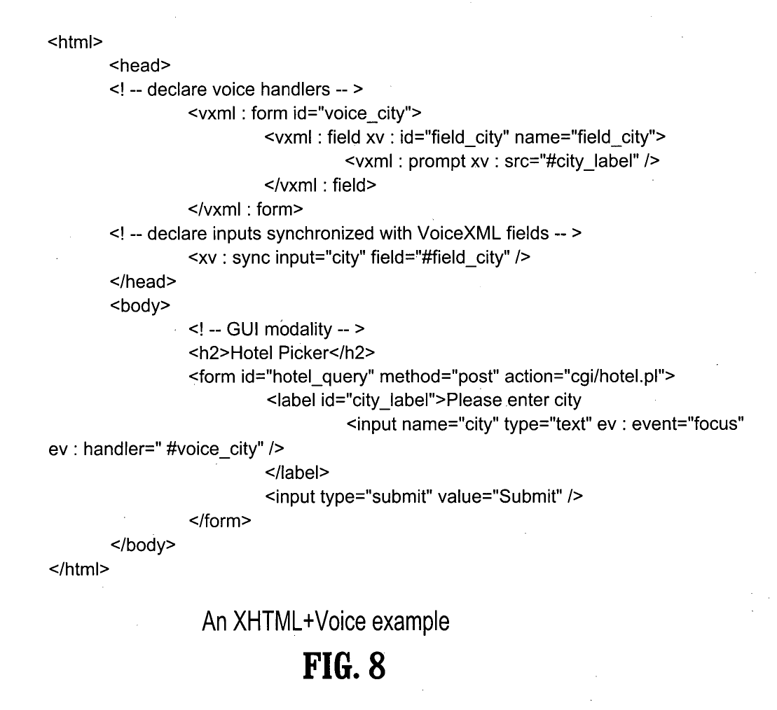

As mentioned before, MMOD clients exchange a set of messages to establish and maintain communication during a multimodal interaction. The sequences of messages exchanged can vary depending on the configuration of the endpoints. For a peer-to-peer type of configuration, an MMOD browser exchanges messages directly with another MMOD browser, whereas in a peer-to-coordinator type of configuration as shown in FIG. 1, communication to another browser is co-ordinated by an intermediary such as the IM. To illustrate the exchange of messages, FIGS. 7a-b depict the sequence of MMOD messages exchanged for the X+Voice embodiment of the invention for the XHTML+Voice example depicted in FIG. 8.

FIGS. 7a-b depict the exchange of messages between the GUI browser adapter 102, the voice browser adapter 112, and the IM 124 depicted in FIG. 6. The synclets 125 synchronize and coordinate these communications over the various channels. Referring first to FIG. 7a, the exchange is initiated by a request 701 for an X+V application generated by an HTML browser. In response, an X+V markup document 702 is returned by the X+V application via the IM to the Voice browser adapter, and an X markup, stripped of voice content, is returned to the GUI browser adapter. A session 703 is established between the GUI browser adapter and the voice browser adapter. A TCP connection 704 is then established between the GIU browser adapter and the IM, and the GUI is locked. The GUI browser adapter then sends a group of messages 705 to the IM. This group includes a SessionInit signal, a StateChanged signal indicating that the client GUI browser adapter is in the Associated state, a StateChanged signal indicating that the client GUI browser adapter is in the Loading state, a TimeSyncRequest signal, and a modality signal. The IM responds by sending two messages 706, a StateChanged signal indicating the IM is in the Associated state, and a TimeSyncResponse signal. The GUI browser adapter sends a StateChanged signal 707 indicating the GUI browser adapter is now loaded. The IM now sends messages 708 to the GUI browser adapter informing it that it has been added as an event listener for a DOMFocusIn event and a Change event, and the GUI browser adapter responds with OK messages 709. A TCP connection 710 is established between the IM and the voice browser adapter, after which the voice browser adapter sends a StateChanged signal to the IM indicating that it is in the Associated state. The IM responds with a StateChanged signal 712 indicating that it is in the Ready state. The IM now sends a StateChanged Ready signal 713 to the GUI browser adapter, which responds with its own StateChanged Ready signal 714. At this point, the GUI browser adapter is unlocked. The GUI browser adapter now sends a DOMEvent signal 715 to the IM to indictae that the GUI browser has focused in on a particular city. Referring now to FIG. 7b, the IM commands 716 the voice browser adapter to load an appropriate document. The voice browser adapter responds with a pair of StateChanged signals 717 indicating that it is loading the document, and that the document is loaded. The IM sends messages 718 to the voice browser adapter informing it that it has been added as an event listener for a DOMFocusIn event and a Change event, and the voice browser adapter responds with OK messages 719. The IM now sends a CommandControl message 721 to the voice browser adapter to execute the document it has loaded, after which the voice browser adapter responds with an OK signal 722. The voice browser adapter then forwards an EventChange 724 to the IM to indicate a selection. The IM responds with a setField command 725 to the GUI browser adapter, which responds with an OK signal 726 to the IM.

Advantages of the Invention

The exemplary aspects of the invention provide the following advantages, all centered around building an extensible, flexible framework that supports a wide range of multimodal applications and their underlying authoring/programming models:
1. Modality-specific user agents (browsers, clients) are made multimodal programming model agnostic, and can coordinate with their peer modalities in a generic and extensible way; this decreases the cost of proliferation of new multimodal programming models and enables the leveraging of existing investments in client devices to take advantage of evolving technology.
2. Server-side infrastructure is made multimodal programming model agnostic: for every specific multimodal programming model a plug-in (synclet) has to be provided. Synclets make use of a generic (modality agnostic) API which provides a rich set of high-level services for multimodal synchronization and coordination; this reduces the cost of migrating an existing server-side installation to an emerging multimodal programming model, and also enables a parallel deployment of diverse (incompatible) multimodal programming technologies using the same setup, significantly reducing the implementation cost for application service providers or hosting centers.
3. The emplary aspects of the invention enable the combination of different multimodal programming models even within a single web application, thus preserving existing investments in multimodal applications while seamlessly extending them (adding features) using the most recent and advanced multimodal technology.

While the present invention has been described in detail with reference to a preferred embodiment, those skilled in the art will appreciate that various modifications and substitutions can be made thereto without departing from the spirit and scope of the invention as set forth in the appended claims.

What is claimed is:

1. A factored multimodal interaction architecture for a distributed computing system, said distributed computing system including a plurality of client browsers and at least one multimodal application server that can interact with said clients by means of a plurality of interaction modalities, said architecture comprising:
an interaction manager with a multimodal interface, wherein said interaction manager can receive a client request for a multimodal application in one interaction modality and transmit said client request in another modality; and
one or more pluggable synchronization modules, wherein each synchronization module implements one of the plurality of interaction modalities between one of the plurality of clients and the server so that a synchronization module for an interaction modality mediates communication between the client and the multimodal interface of the interaction manager.

2. The architecture of claim 1, further comprising a servlet filter that can intercept a client request for a multimodal application, and can pass that client request and a library of synchronization modules to the interaction manager, wherein the interaction manager can select a synchronization module appropriate for the client request from the library of synchronization modules.

3. The architecture of claim 1, further comprising a browser adapter for each client browser, each said browser adapter including the multimodal interface, wherein each multimodal interface of a client browser adapter and the multimodal interface of the interaction manager can communicate via a plurality of multimodal messages, and wherein a synchronization module for an interaction modality is instantiated by the interaction manager upon receiving a client request for that interaction modality, and wherein the synchronization module implements an exchange of multimodal messages between the multimodal interface of the client browser adapter and the multimodal interface of the interaction manager.

4. The architecture of claim 3, further comprising a synchronization proxy for each client for encoding said multimodal messages in an internet communication protocol.

5. The architecture of claim 3, wherein the multimodal messages include multimodal events and multimodal signals.

6. The architecture of claim 1, wherein the interaction manager is a state machine having an associated state, a loaded state, a ready state, and a not-associated state; the client browser adapter is a state machine having an associated state, a loading state, a loaded state, and a ready state; and a synchronization module is a state machine having an instantiated state, a loaded state, a ready state, and a stale state.

7. The architecture of claim 6, wherein the client browser adapter enters the associated state when a connection to either the interaction manager or another client has been established; the client browser adapter enters the loading state when it is loading a document; the client browser adapter enters the loaded state when it has completed loading the document; and the client browser adapter enters the ready state when it is ready for multimodal interaction.

8. The architecture of claim 6, wherein the synchronization module enters the instantiated state when it has been instantiated but has no document to process; the synchronization module enters the loaded state when it has been given a document to process but is waiting for a loaded signal from a client; the synchronization module enters the ready state when it is ready to receive events and send synchronization commands; and the synchronization module enters the stale state when the document being handled is no longer in view for the client.

9. The architecture of claim 6, wherein the interaction manager enters the associated state when any non-stale synchronization module is in the instantiated state; the interaction manager enters the loaded state if any non-stale synchronization module is in the loaded state; the interaction manager enters the ready state if all non-stale synchronization modules are in the ready state; and the interaction manager enters the not-associated state when there is no client session associated with it.

10. The architecture of claim 1, further comprising an event control interface, by which a client browser adapter or the interaction manager can register or remove an event listener, or dispatch an event to another client browser adapter or to the interaction manager; a command control interface by which a client browser adapter or the interaction manager can modify the state of another a client browser adapter by issuing a synchronization command; and an event listener interface that can provide an event handler to a client browser adapter or the interaction manager.

11. A factored multimodal interaction architecture for a distributed computing system, said distributed computing system including a plurality of clients and at least one application server that can interact with said clients by means of a plurality of interaction modalities, said architecture comprising:
a servlet filter that can intercept a client request for a multimodal application;
an interaction manager with a multimodal interface, wherein said interaction manager can receive said client request for a multimodal application in one interaction modality and transmit said client request in another modality;
a browser adapter for each client browser, each said browser adapter including the multimodal interface, wherein the multimodal interface of a client browser adapter and the multimodal interface of the interaction manager can communicate via a plurality of multimodal messages, and wherein each browser adapter inclues a synchronization proxy for encoding said multimodal messages in an internet communication protocol; and
one or more pluggable synchronization modules, wherein each synchronization module implements one of the plurality of interaction modalities between one of the plurality of clients and the server so that a synchronization module can receive events and send commands over an interaction modality channel between the multimodal interface of the client browser adapter and the multimodal interface of the interaction manager,
wherein said servlet filter can pass a library of synchronization modules to the interaction manager, wherein the interaction manager can select and instantiate a synchronization module appropriate for the client request from the library of synchronization modules to implement an exchange of multimodal messages between the multimodal interface of the client browser adapter and the multimodal interface of the interaction manager.

12. The architecture of claim 11, wherein the client browser adapter is a state machine having an associated state when a connection to either the interaction manager or another client has been established; a loading state when it is loading a document; a loaded state when it has completed loading the document; and a ready state when it is ready form multimodal interaction.

13. The architecture of claim 12, wherein the synchronization module is a state machine having an instantiated state when it has been instantiated but has no document to process; a loaded state when it has been given a document to process but is waiting for a loaded signal from a client; a ready state when it is ready to receive events and send synchronization commands; and a stale state when the document being handled is no longer in view for the client.

14. The architecture of claim 13, wherein the interaction manager is a state machine having an associated state when any non-stale synchronization module is in the instantiated state; a loaded state when any non-stale synchronization module is in the loaded state; a ready state if all non-stale synchronization modules are in the ready state; and a not-associated state when there is no client session associated with it.

15. The architecture of claim 11, further comprising an event control interface, by which a client browser adapter or the interaction manager can register or remove an event listener, or dispatch an event to another client browser adapter or to the interaction manager; a command control interface by which a client browser adapter or the interaction manager can modify the state of another a client browser adapter by issuing a synchronization command; and an event listener interface that can provide an event handler to a client browser adapter or the interaction manager.

16. A factored multimodal interaction architecture for a distributed computing system, said distributed computing system including a plurality of clients and at least one application server that can interact with said clients by means of a plurality of interaction modalities, said architecture comprising:
a servlet filter that can intercept a client request for a multimodal application;
an interaction manager with a multimodal interface, wherein said interaction manager can receive said client request for a multimodal application in one interaction modality and transmit said client request in another modality, said interaction manager being a state machine having an associated state, a loaded state, a ready state, and a not-associated state;
a browser adapter for each client browser, each said browser adapter including the multimodal interface, wherein the multimodal interface of a client browser adapter and the multimodal interface of the interaction manager can communicate via a plurality of multimodal messages, and wherein each browser adapter inclues a synchronization proxy for encoding said multimodal messages in an internet communication protocol, said client browser adapter being a state machine having an associated state, a loading state, a loaded state, and a ready state;
one or more pluggable synchronization modules, wherein each synchronization module implements one of the plurality of interaction modalities between one of the plurality of clients and the server so that a synchronization module can receive events and send commands over an interaction modality channel between the multimodal interface of the client browser adapter and the multimodal interface of the interaction manager, each said synchronization module being a state machine having an instantiated state, a loaded state, a ready state, and a stale state;
an event control interface, by which a client browser adapter or the interaction manager can register or remove an event listener, or dispatch an event to another client browser adapter or to the interaction manager;
a command control interface by which a client browser adapter or the interaction manager can modify the state of another a client browser adapter by issuing a synchronization command; and
an event listener interface that can provide an event handler to a client browser adapter or the interaction manager,
wherein said servlet filter can pass a library of synchronization modules to the interaction manager, wherein the interaction manager can select and instantiate a synchronization module appropriate for the client request from the library of synchronization modules to implement an exchange of multimodal messages between the multimodal interface of the client browser adapter and the multimodal interface of the interaction manager.

17. The architecture of claim 16, wherein the client browser adapter enters the associated state when a connection to either the interaction manager or another client has been established; the client browser adapter enters the loading state when it is loading a document; the client browser adapter enters the loaded state when it has completed loading the document; and the client browser adapter enters the ready state when it is ready form multimodal interaction.

18. The architecture of claim 16, wherein the synchronization module enters the instantiated state when it has been instantiated but has no document to process; the synchronization module enters the loaded state when it has been given a document to process but is waiting for a loaded signal from a client; the synchronization module enters the ready state when it is ready to receive events and send synchronization commands;
and the synchronization module enters the stale state when the document being handled is no longer in view for the client.

19. The architecture of claim 16, wherein the interaction manager enters the associated state when any non-stale synchronization module is in the instantiated state; the interaction manager enters the loaded state if any non-stale synchronization module is in the loaded state; the interaction manager enters the ready state if all non-stale synchronization modules are in the ready state; and the interaction manager enters the not-associated state when there is no client session associated with it.
